(19) United States
(12) Patent Application Publication
(10) Pub. No.: US 2012/0248816 A1
(43) Pub. Date: Oct. 4, 2012

(54) RAIN SHIELD AND A TILT AND SLIDE WINDOW HAVING SAID RAIN SHIELD SET THEREON

(76) Inventor: Jia-Wei WAN, New Taipei (TW)

(21) Appl. No.: 13/076,435

(22) Filed: Mar. 31, 2011

(51) Int. Cl. B60J 1/00; E05B 65/00; E06B 7/03; E05D 15/48

(52) U.S. Cl. 296/154; 296/146.2; 49/149; 454/214

(57) ABSTRACT

A rain shield comprising a first face, and a second face disposed on an opposite side thereof, wherein a plurality of first pores are defined on said first face and a plurality of second pores are defined on said second face. Each first pore is corresponding to a second pore and are connected by a slope passage. With the angled passage provided in the rain shield, it can be used for ventilation and avoid the permeation of rain.

### FIELD OF THE INVENTION

The present invention relates to a shield, more specifically, a rain shield having multiple porous configurations defined thereon as ventilators adapted for a window to achieve the benefit for ventilation and to avoid the permeation of rain.

### DESCRIPTION OF PRIOR ART

A traditional tilt and slide window, as shown in FIG. 1, includes a window frame (10), having a first, a second panel and a screen window set therein. The slidable first and second panels can be moved to open or close the window. In some situations, like a rainy day, the window is often remained closed to avoid the permeation of water. However, the ventilation is also blocked and by using air conditioning device for the air circulation is not economical or eco-friendly. Furthermore, the screen window does not possess any safety feature when the window is opened and out-of-balance children or elderly person may fall out from the window. Therefore, to provide a window structure which does not need to be closed during a rainy day for the air circulation with extra safety feature has become the main objective of the present invention.

### SUMMARY OF THE INVENTION

To achieve above objective, a rain shield which possesses feature of good ventilation and doesn't allow the permeation of water during a rainy day is consisted of a first face, and a second face disposed on an opposite side thereof, characterized in that a plurality of first pores are defined on said first face and a plurality of second pores are defined on said second face; each first pore is corresponding to a second pore and are connected by a slope passage.

Further, said first pore is connecting to an upper or higher end of the passage, and said passage is slanted downwardly to connect said second first pore at a lower end.

Said second pore has a curve rim.

Above-mentioned rain shield can also be adapted for a tilt slide window, which consists of a window frame and said rain shield is set freely therein for the sliding movement.

Moreover, a locking device is further included. Said locking device has a male and a female member, the male member has a hook provided freely therein, being able to move vertically. A resilient element is disposed in said male member and attached to an end of the hook. A detachable fixing member engages with said male member further to restrain the movement of the hook. Said female member has a groove for receiving said hook of the male member. Said male member is provided at a side of the rain shield approximating to the frame, and said female member is provided at the frame, corresponding to the location of the male member.

By installing the rain shield, the multiple angled passages can bring fresh air to the indoor, improving air circulation or ventilation, avoiding entry of the rain. Moreover, unlike the conventional screen window, which can be easily broken, the shield can be made of harden material to prevent damage from animal or human. With the additional locking device, it can also be served as a safety device to avoid children, elderly person or objects falling off from the window. The rain shield can also be installed onto a door of an automobile for the same purpose.

### BRIEF DESCRIPTION OF DRAWINGS

FIG. 1 is a frontal perspective view of a traditional tilt slide window.

FIG. 2 is a partial front perspective view of a rain shield claimed in the present invention.

FIG. 3 is a cross-section view of the rain shield of FIG. 2.

FIG. 4 is an embodiment having the claimed rain shield adapted for a tilt slide window.

FIG. 5 is an exploded view of a locking device set on the window.

FIG. 6 is a second embodiment of the present invention adapted for a tilt slide window.

FIG. 7 is a third embodiment of the present invention adapted for a tilt slide window.

FIG. 8 is an exploded view of another locking device set on the window.

FIG. 9 is a forth embodiment of the present invention adapted for a door of an automobile.

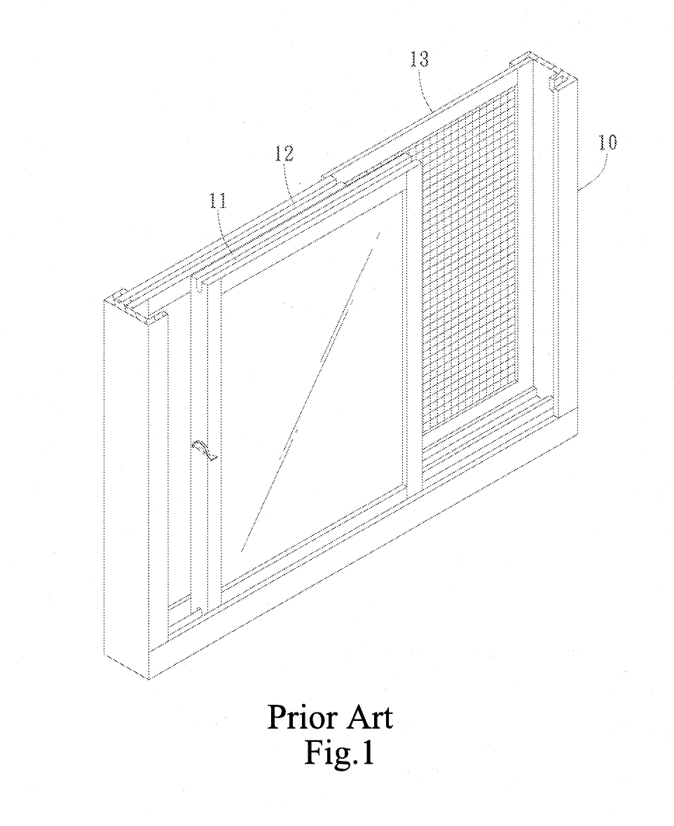

### DETAILED DESCRIPTION OF PREFERRED EMBODIMENTS

The preferred embodiments of the present invention are described in details hereinafter, according to the appended drawings.

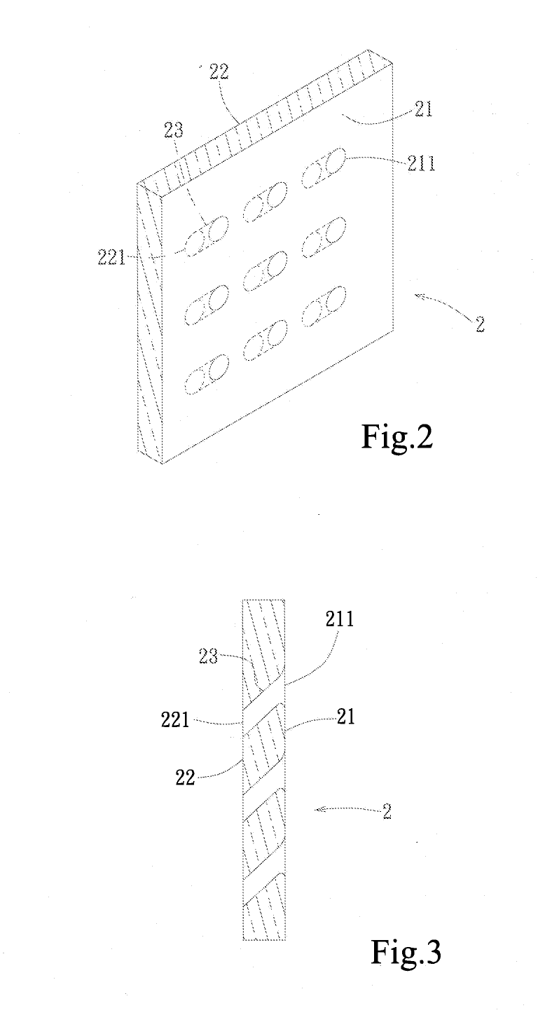

Referring to FIGS. 2 and 3, a rain shield (2) consists of a first face (21), and a second face (22) disposed on an opposite side thereof, characterized in that a plurality of first pores (211) are defined on said first face (21) and a plurality of second pores (221) are defined on said second face (22). Each first pore (211) is corresponding to a second pore (221) and both pores (211, 221) are connected by a slope passage (23).

Said first pore (211) has a curve rim as circumference and is connecting to an upper or higher end of the passage (23), and said passage (23) is slanted downwardly to connect said second pore (221) at a lower end.

When using the rain shield (2), the second face (22) is facing indoor and the first face (21) is facing outdoor. Since pores (211) of the first face (21) are lower than pores (221) of the second faces (22), when said pores (211, 221) are connected by the passage (23), the fresh air from outside can be brought to the inside of the room but keeps the falling water, e.g. rain at outside, preventing it from wetting the furniture in the house. Even if the water enters the inside through the second pore (221) and the passage (23) by capillarity, the curve rim of the first pore (211) can lead the water to the passage (23) set under and guiding toward outside.

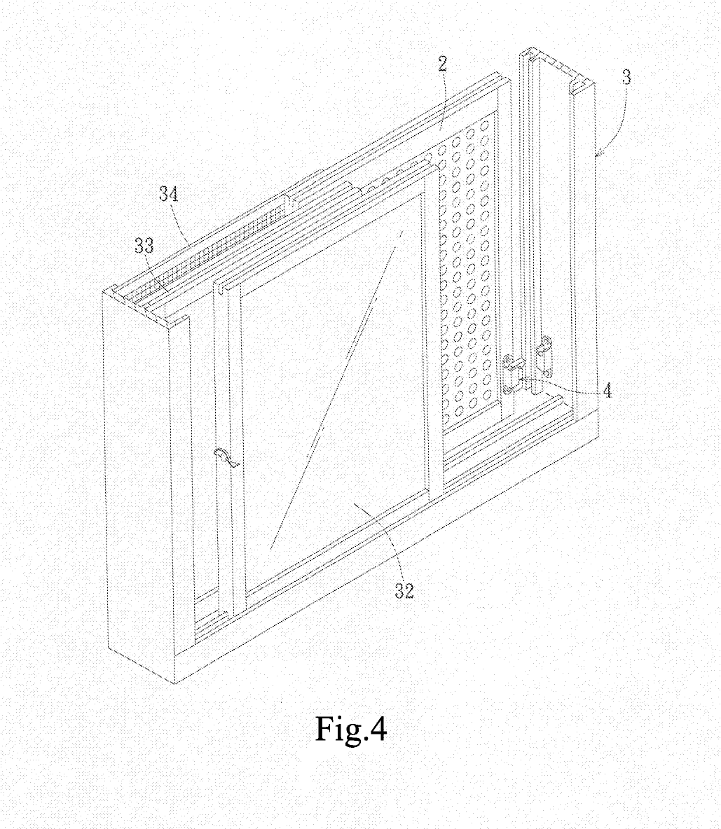

FIG. 4 shows a first embodiment of a tilt and slide window structure having said rain shield installed thereon. The window structure consists of a window frame (3), a slidable first and a second panel (32, 33), spaced by a predetermined distance are mounted in the frame (3), a slidable rain shield (2) mounted in the frame (3), spacing with said second panel (33), and a slidable screen window (34) engaged to the frame and spaced with said rain shield (2). The functions of the frame (3), the first and second panels (32, 33) and the screen window (34) are well known by the person who has ordinary skill in the art, therefore, no description is stated hereafter.

For the usage on a normal weather, said window may function equally as the conventional tilt and slide window. However, when it starts raining, the user can slide the rain shield (2) and leave the window opened.

For safety measure, a locking device (4) can be applied further to the window, locking the rain shield (2) when is closed.

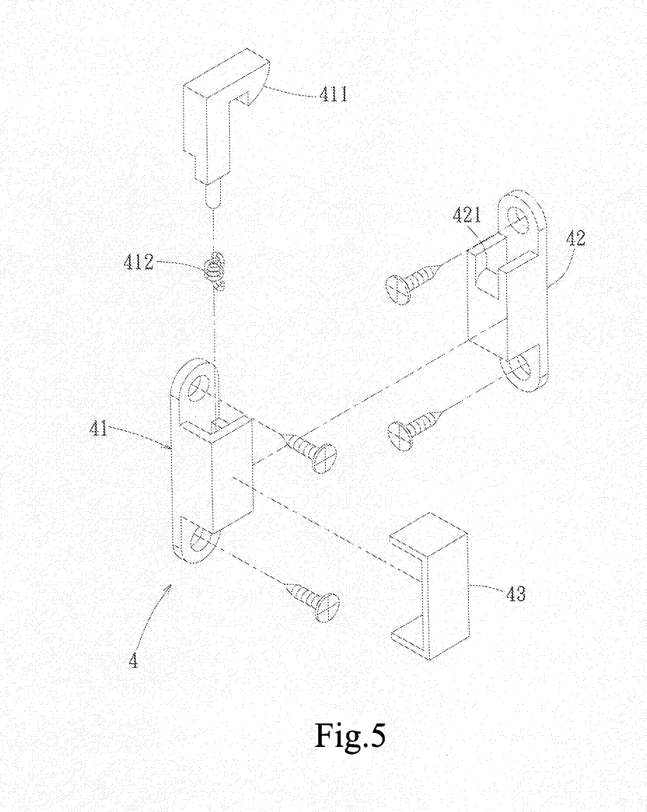

As shown in FIG. 5, said locking device (4) comprises a male (41) and a female member (42); the male member (41) includes a hook (411) provided freely therein, and is allowed to move vertically. A resilient element (412) is disposed inside said male member (41) and is attached to an end of the hook (411), a detachable fixing member (43) engages with said male member (41) further to block the movement of the hook (411). Said female member (42) has a groove (421) for receiving said hook (411) of the male member (41). The male member (41) is provided at a side of the rain shield (2) approximating to a side of the frame (3), and said female member (42) is provided at the same side of the frame (3), corresponding to the location of said male member (41).

As shutting the rain shield (2), the hook (411) of the male member (41) engages the corresponding groove (421) on the female member (42). The resilient element (412) which is attached to the hook (411) can be a retracting spring, providing a force to retract the hook (411) to its original position and fixing the hook (411) and the groove (421).

The fixing member (43), as shown in the embodiment, can be a C-shape object, by using two extreme ends thereof against male member (41) and the hook (411) respectively, the fixing member (43) blocks the vertical movement of the hook (411) and avoiding the disengagement of the hook (411) from the groove (421).

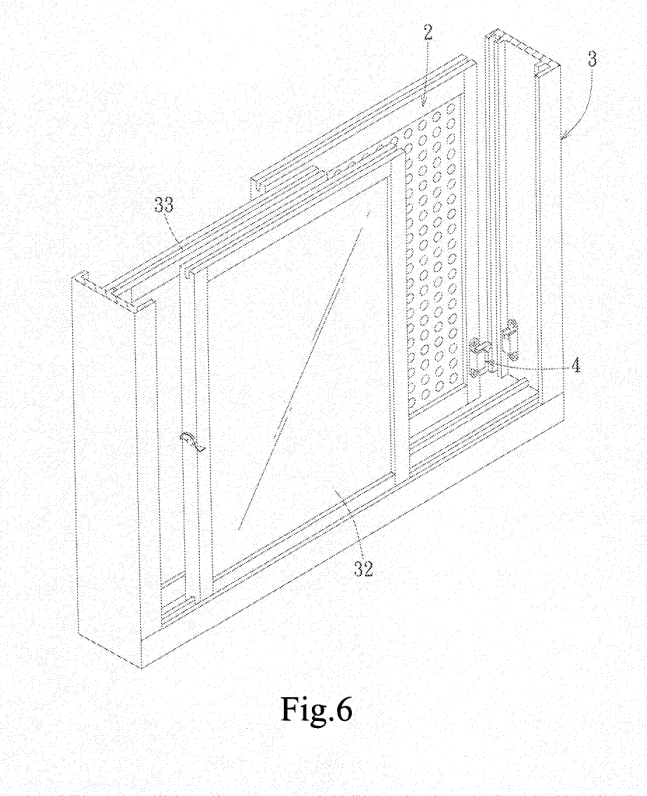

FIG. 6 illustrates a second embodiment of the present invention, it discloses a window structure consists of a window frame (3), a slidable first and a second panel (32, 33), spaced by a predetermined distance are mounted in the frame (3), a slidable rain shield (2) mounted in the frame (3) and is spaced with said second panel (33), and a locking device (4) attached to the window. As the functions of the rain shield (2) and locking device (4) are taught previously, no further description is stated hereafter.

In the second embodiment, by replacing the conventional screen window (13) with rain shield (2), the window can provide ventilation without worrying the interior of the room being wet on a rainy day, and with the installation of the lock (4) to gain additional safety measure to prevent any accident.

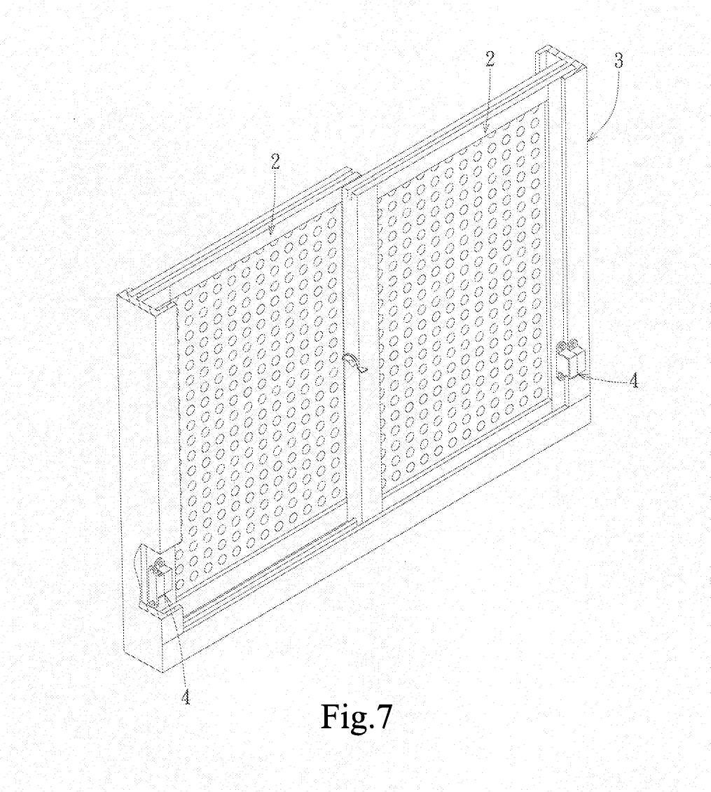

A third embodiment of the present invention is shown in FIG. 7, which is recommended to be used in a building. The window structure includes a frame (3), two slidable rain shields (2) mounted therein, a manual locking device (5) and two lock assemblies (4), each is set on a side of the frame (3).

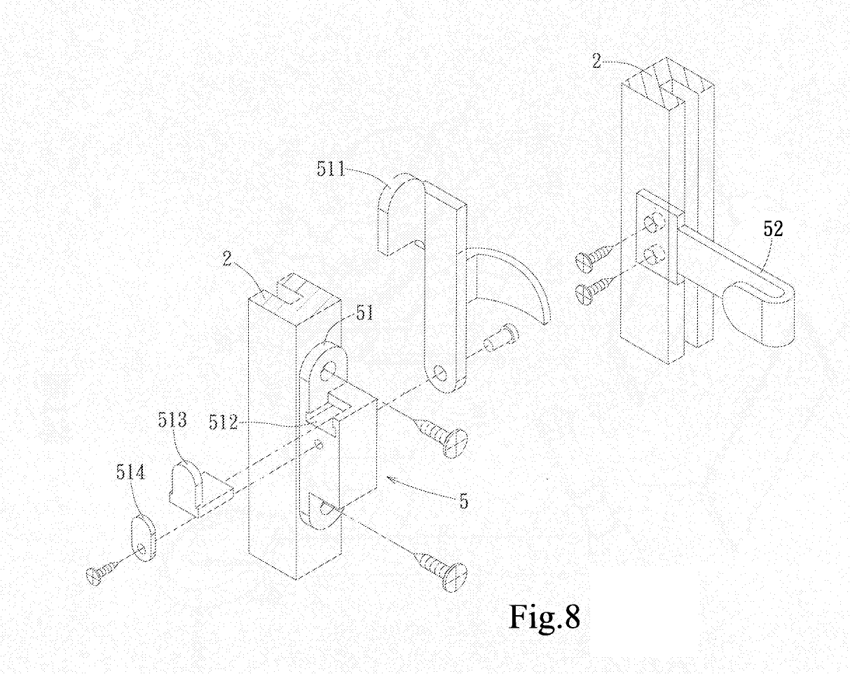

Referring to FIG. 8, the manual locking device (5) comprises a base (51), a receiving member (52), each is provided at a lateral side of the rain shield (2); a movable locking member (511) for engaging said receiving member (52) is attached to the base (51) pivotally, a groove (512) is set at a lateral side of the base (51), a sliding member (513) is set freely in the groove (512) and a stop (514) pivotally jointed to the base (51) for blocking the movement of the sliding member (513).

The locking member (511) can be turned and engaged with the receiving member (52). The sliding member (513) is then inserted into the groove (512) and the stop (514) is lifted to fix the receiving member (513) in the groove (512), disabling the movability of the locking member (511) and fastening the rain shields (2).

By replacing the conventional glass with the rain shield (2), it provides a full-time ventilation to the building, reducing the usage of air conditioning device, and the locks (4) can fix the rain shields (2) to the frame (3), minimizing the risk of any accident.

Said two rain shields (2) can also be replaced by a single piece (not shown) and the installation locks (4) can be optional. The rain shield (2) can also be applied to other area where good ventilation or air circulation is required, e.g. stadium, gymnasium or recreation center.

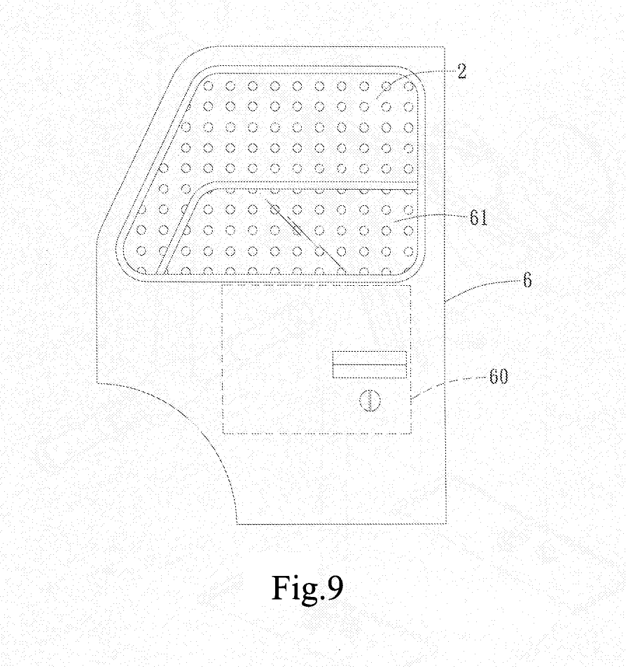

Referring to FIG. 9, the forth embodiment having a rain shield (2) adapted for a door of an automobile (not shown), which comprises a door body (6), a car window (61), a rain shield (2) and an elevating device (60). Said rain shield (2) is provided on to the door body (6) and is spaced with the car window (61). Said rain shield (2) is set in the innermost side of the door (6), and said car window (61) is provided at the outermost side of the car door (6). Said elevating device (60) connects said car window (61) and rain shield (2) for ascending and descending both respectively.

Since the inner side of the automobile is a confined space, driver usually turns on the air conditioning device to maintain the air circulation when car windows (61) are closed, but it consumes extra fuel, generating unnecessary waste. To reduce fuel consumption, some drivers may maintain the window (61) opened when stayed in a parked automobile, however, the risk of safety of the driver is increased. By adding said rain shield (2) to the car door body (6), driver can maintain the ventilation under a rainy day without using air conditioning device, reducing fuel consumption and further increase the safety of driver when stayed in a parked automobile.

1. A rain shield comprising:
a first face, and a second face disposed on an opposite side thereof; characterized in that a plurality of first pores are defined on said first face and a plurality of second pores are defined on said second face; each first pore is corresponding to a second pore and are connected by a slope passage.

2. The rain shield of claim 1, wherein said first pore connects to an upper end of the passage, and said passage is slanted downwardly to connect said second pore.

3. The rain shield of claim 2, wherein said second pore has a curve rim.

4. A tilt and slide window having said rain shield installed therein comprising: a window frame; and at least one rain shield disposed slidingly upon said frame; the rain shield comprising: a first face, and a second face disposed on an opposite side thereof; wherein, a plurality of first pores are defined on said first face and a plurality of second pores are defined on said second face; each first pore is corresponding to a second pore and are connected by a slope passage.

5. The tilt and slide window of claim 4, wherein said first pore connects to an upper end of the passage, and said passage is slanted downwardly to connect said second pore.

6. The tilt and slide window of claim 5, wherein said second pore has a curve rim.

7. The tilt and slide window of claim 4, wherein a locking device is further included; said lock has a male and a female member, the male member including a hook provided freely therein, and is allowed to move vertically; a resilient element disposed inside said male member and is attached to an end of the hook, a detachable fixing member engages with said male member further to restrain the movement of the hook; said female member has a groove for receiving said hook of the male member.

8. The tilt and slide window of claim 7, wherein said male member is provided at a side of the rain shield approximating to the frame, and said female member is provided at the frame, corresponding to the location of said male member.

9. The tilt and slide window of claim 4, wherein a manual locking device is further included; said lock has a base, a receiving member, a movable locking member for engaging said receiving member is attached to the base pivotally, a groove set at a side of the base, a sliding member set freely in the groove and a stop pivotally jointed to the base for blocking the movement of the sliding member.

10. The tilt and slide window of claim 4, wherein the frame includes a first and a second panel slidingly set therein; said first and second panels are spaced by a predetermined distance.

11. The tilt and slide window of claim 4, wherein the frame includes a first, a second panel and a screen window slidingly set therein; said first and second panels and screen window are spaced by a predetermined distance.

12. The tilt and slide window of claim 4, wherein an additional rain shield is further set slidingly between said panels.

13. A door of an automobile having rain shield installed therein comprising a door body with a car window set thereon; a rain shield disposed on to the door body and is spaced with the car window; the rain shield comprising: a first face, and a second face disposed on an opposite side thereof; wherein, a plurality of first pores are defined on said first face and a plurality of second pores are defined on said second face; each first pore is corresponding to a second pore and are connected by a slope passage; an elevating device connecting said car window and rain shield for ascending and descending both respectively.

14. The door of an automobile of claim 11, wherein said first pore connects to an upper end of the passage, and said passage is slanted downwardly to connect said second pore.

15. The door of an automobile of claim 11, wherein said second pore has a curve rim.
